(19) United States
(12) Patent Application Publication
(10) Pub. No.: US 2004/0072497 A1
(43) Pub. Date: Apr. 15, 2004

(54) Apparatus for fabricating plasma display panel and method of fabricating the same

(76) Inventors: Toshiaki Hirano, Tokyo (JP); Takeshi Kokura, Tokyo (JP)

Correspondence Address: DICKSTEIN SHAPIRO MORIN & OSHINSKY LLP, 1177 AVENUE OF THE AMERICAS (6TH AVENUE), 41 ST FL., NEW YORK, NY, 10036-2714, US

(21) Appl. No.: 10/617,233

(22) Filed: Jul. 11, 2003

(30) Foreign Application Priority Data
Jul. 17, 2002 (JP) 2002-207686

(51) Int. Cl. H01J 9/46; H05B 33/10

(52) U.S. Cl. 445/66

(57) ABSTRACT

An apparatus for fabricating a plasma display panel, the apparatus forming a protection film on a substrate of a plasma display panel in a display area, includes (a) a vacuum chamber, (b) a feeder which feeds the substrate in a first direction in the vacuum chamber, and (c) a plurality of evaporation sources located in alignment with the display area of the substrate when the substrate is in a film-forming position, wherein at least one of the evaporation sources is located in each of first areas defined as areas extending from edges of a maximum substrate among substrates being able to be fed by the feeder which edges extend in the first direction, inwardly of the substrate by a predetermined length in a second direction perpendicular to the first direction

### BACKGROUND OF THE INVENTION

1. Field of the Invention

The invention relates to an apparatus for fabricating a plasma display panel, specifically, forming a protection film on a substrate, and further to a method of doing the same. More particularly, the invention relates to an apparatus for fabricating a plasma display panel which is capable of forming a protection film having uniform characteristics, and a method of doing the same.

2. Description of the Related Art

A plasma display panel is comprised of a front substrate and a rear substrate.

A front substrate is comprised of a transparent substrate, a plurality of scanning electrodes formed on the transparent substrate in parallel with one another, a plurality of common electrodes formed on the transparent substrate in parallel with and alternately of the scanning electrodes, a transparent dielectric layer formed on the transparent substrate so that the scanning and common electrodes are covered with the transparent dielectric layer, and a protection film formed on the transparent dielectric layer. The protection film is composed of magnesium oxide (MgO), for instance.

A rear substrate is comprised of an electrically insulating substrate, a plurality of data electrodes formed on the electrically insulating substrate in parallel with one another, a dielectric layer formed on the electrically insulating substrate such that the data electrodes are covered with the dielectric layer, a partition wall formed on the dielectric layer for defining cells in a matrix, and a phosphor layer covering sidewalls of the partition wall and an exposed surface of the dielectric layer therewith.

The front and rear substrates are adhered to each other such that the scanning and common electrodes extend perpendicularly to the data electrodes. Then, the front and rear substrates are hermetically sealed to each other. After air existing in a space defined between the front and rear substrates is exhausted, discharge gas is introduced into the space. Thus, there is completed a plasma display panel.

The protection film comprised of a magnesium oxide (MgO) film protects the transparent dielectric layer from sputtering caused by ionized discharge gas, and further emits secondary electrons to thereby facilitate discharge, during discharge is being carried out. In accordance with a difference in characteristics of magnesium oxide films, the protection films have secondary electron emission characteristics and resistances to sputtering both different from one another, resulting in a difference in a voltage at which a writing discharge starts in each of cells, a voltage at which a writing discharge is wrongly generated in each of cells, a discharge delay time in each of cells, and a lifetime of a cell. Herein, a discharge delay time is defined as a period of time from application of a pulse across electrodes until actual generation of discharge. A discharge delay time is usually about 3 microseconds at greatest.

Japanese Patent Application Publications Nos. 2001-118518, 2002-83546, and 2002-33054 have suggested a method of controlling crystal structure and alignment of a magnesium oxide film for enhancing secondary electron emission characteristics. For instance, Japanese Patent Application Publication No. 2001-118518 sets forth that a magnesium oxide film containing (110)- and (100)-aligned crystals or having a crystal column inclining at 5 to 60 degrees relative to a thickness-wise direction could have enhanced characteristics of secondary electron emission, lower a voltage at which a writing discharge starts, and shorten a discharge delay time.

FIG. 1 is a side view of a conventional apparatus for forming a protection film comprised of a magnesium oxide film. The apparatus illustrated in FIG. 1 is one disclosed in the above-mentioned Japanese Patent Application Publication No. 2002-83546.

In the conventional apparatus illustrated in FIG. 1, a magnesium oxide film is successively formed by vacuum evaporation on a transparent substrate (for instance, comprised of a glass substrate) 101 in a display area 102. The conventional apparatus is designed to have a vacuum chamber (not illustrated) in which a plurality of MgO evaporation sources 103 is arranged in a line in a direction perpendicular to a direction in which the substrate 101 is fed. The evaporation sources 103 are arranged such that a magnesium oxide film to be formed in the display area 102 has a uniform thickness. A plurality of electron guns (not illustrated) is arranged in the vacuum chamber.

The electron guns radiate electron beams to the evaporation sources 103 for evaporating magnesium oxide (MgO), while the transparent substrate 101 is fed in the vacuum chamber at a constant speed. When the transparent substrate 101 reaches above the evaporation sources 103, evaporated magnesium oxide is adhered to a surface of the transparent substrate 101, and thus, a magnesium oxide film (not illustrated) is formed on the transparent substrate 101 in the display area 102. The thus formed magnesium oxide film constitutes a protection film of the front substrate.

However, the above-mentioned conventional apparatus is accompanied with the following problems.

In the formation of a magnesium oxide film through the use of the apparatus illustrated in FIG. 1, even if the evaporation sources 103 are appropriately arranged and electron beams emitted from the electron guns are controlled appropriately for forming a magnesium oxide film having a thickness uniform in a width-wise direction of the transparent substrate 101, a resultant magnesium oxide film might have deteriorated characteristics at opposite ends in the width-wise direction. Hence, if the transparent substrate 101 having such a magnesium oxide film as a protection film is used in a plasma display panel, cells located at an edge of the display area 102 would have problems such as an increase in a voltage at which a writing discharge starts, reduction in a voltage at which a writing discharge is wrongly generated, an increase in a discharge delay time, and reduction in a voltage lifetime.

If a voltage at which a writing discharge starts is increased and a voltage at which a writing discharge is wrongly generated increases, a driving margin for a writing discharge is narrowed, resulting in that it is difficult to properly drive a plasma display panel. If a discharge delay time is increased, a period of time during which a pulse is applied to electrodes has to be made longer, resulting in that it would not be possible to drive a plasma display panel at a high rate, which would make it difficult to fabricate a plasma display panel in a large size. In addition, if a voltage lifetime is reduced, it would be unavoidable to increase a thickness of a protection film, resulting in an increase in fabrication costs.

The evaporation sources have been conventionally arranged such that a protection film had a uniform thickness. When a plasma display panel was fabricated in one-piece making, that is, one display area was formed out of a single substrate, the conventional apparatus was sufficiently able to fabricate a plasma display panel including a display area having a desired size, and hence, the above-mentioned problems were not caused.

However, with recent development in a size of a plasma display panel, an apparatus has to deal with a substrate including a display area having a size approximately close to a limitation of the apparatus, resulting in that the above-mentioned problems are caused.

For instance, if a 55-size or greater plasma display panel is formed of a single substrate, the above-mentioned problems will be caused at edges of the substrate. If two display areas arranged in a direction perpendicular to a direction in which a substrate is fed are taken out of a single substrate, no problems would be caused in taking out two 42-size display areas, but the above-mentioned problems would be caused in taking out two 50-size or greater display areas. Furthermore, if three or more 42-size display areas are taken out of a single substrate, the above-mentioned problems would be caused.

### SUMMARY OF THE INVENTION

In view of the above-mentioned problems in the conventional apparatus, it is an object of the present invention to provide an apparatus for fabricating a plasma display panel which apparatus is capable of forming a protection film on a substrate which protection film has enhanced characteristics of secondary electron emission, enhanced resistance to sputtering, and has a uniform structure.

It is also an object of the present invention to provide a method of fabricating a plasma display panel which is capable of doing the same.

In one aspect of the present invention, there is provided an apparatus for fabricating a plasma display panel, the apparatus forming a protection film on a substrate of a plasma display panel in a display area, includes (a) a vacuum chamber, (b) a feeder which feeds the substrate in a first direction in the vacuum chamber, and (c) a plurality of evaporation sources located in alignment with the display area of the substrate when the substrate is in a film-forming position, wherein at least one of the evaporation sources is located outside the display area in a second direction perpendicular to the first direction.

In the apparatus, at least one evaporation source is arranged outside the display area in the second direction. This ensures that evaporated material flies to all points in the display area from outside of the display area in the second direction. As a result, it would be possible to form a protection film having uniform crystal alignment, entirely in the display area. Thus, it is possible for the protection film to have enhanced characteristics of secondary electron emission and an enhanced resistance to sputtering entirely in the display area.

There is further provided an apparatus for fabricating a plasma display panel, the apparatus forming a protection film on a substrate of a plasma display panel in a display area, including (a) a vacuum chamber, (b) a feeder which feeds the substrate in a first direction in the vacuum chamber, and (c) a plurality of evaporation sources located in alignment with the display area of the substrate when the substrate is in a film-forming position, wherein at least one of the evaporation sources is located in each of first areas defined as areas extending from edges of a maximum substrate among substrates being able to be fed by the feeder which edges extend in the first direction, inwardly of the substrate by a predetermined length in a second direction perpendicular to the first direction.

For instance, the predetermined length is equal to 40 mm.

The at least one of the evaporation sources may be located outside the first area in the second direction.

It is preferable that the protection film is formed by vacuum evaporation.

The apparatus may further include an electron gun which irradiates electron beams to the evaporation sources for heating and evaporating the evaporation sources.

It is preferable that an angle defined by a first line and a second line is equal to or smaller than 80 degrees wherein the first line is defined as a line, when the substrate is in the film-forming position, connecting each of the at least one of the evaporation sources to a point on each of lines extending in the first direction at a distance of the predetermined length from the edges of the substrate which point is closest to each of the at least one of the evaporation sources, and the second line is defined as a line extending in the second direction from the at least one of the evaporation sources.

It is preferable that an angle defined by a first line and a second line is equal to or smaller than 80 degrees wherein the first line is defined as a line, when the substrate is in the film-forming position, connecting each of the at least one of the evaporation sources to a point on the substrate which point is closest to each of the at least one of the evaporation sources, and the second line is defined as a line extending in the second direction from the at least one of the evaporation sources.

It is preferable that a distance between the evaporation sources and the substrate may be selected from a plurality of distances different from one another, and, assuming that the display area has a length A or B (A>B) in the second direction, a distance selected when the display area has a length B is equal to or smaller than a distance selected when the display area has a length A.

For instance, each of the evaporation sources may be comprised of magnesium oxide, and the apparatus may form a protection film comprised of a magnesium oxide film.

It is preferable that the magnesium oxide film has a face-centered cubic structure (fcc).

It is preferable that the magnesium oxide film has a (111)-aligned surface.

There is further provided an apparatus for fabricating a plasma display panel, the apparatus forming a protection film on a substrate of a plasma display panel in a display area, including (a) a vacuum chamber, (b) a feeder which feeds the substrate in a first direction in the vacuum chamber, (c) a plurality of evaporation sources located in alignment with the display area of the substrate when the substrate is in a film-forming position, and (d) a mask positioned between the substrate and the evaporation sources, and having an opening in alignment with the display area, wherein at least one of the evaporation sources is located outside the opening in a second direction perpendicular to the first direction and parallel with a surface of the substrate.

In another aspect of the present invention, there is provided a method of fabricating a plasma display panel, including the step of forming a protection film on a substrate of the plasma display panel in a display area, the step includes (a) feeding the substrate in a first direction in a vacuum atmosphere, and (b) heating and evaporating a plurality of evaporation sources at least one of which is located outside the display area in a second direction perpendicular to the first direction, the evaporation sources being positioned facing the display area of the substrate.

For instance, the protection film is formed by vacuum evaporation.

It is preferable that an angle defined by a first line and a second line is equal to or smaller than 80 degrees wherein the first line is defined as a line connecting each of the at least one of the evaporation sources located outside the display area in the second direction among the evaporation sources, to a point in the display area which point is closest to the at least one of the evaporation sources, and the second line is defined as a line extending in the second direction from the at least one of the evaporation sources.

For instance, the substrate has at least two display areas each having a size of 50-size or greater.

For instance, the substrate has at least three display areas.

For instance, the display area has a size of 55-size or greater or 60-size or greater.

The advantages obtained by the aforementioned present invention will be described hereinbelow.

In accordance with the present invention, at least one evaporation source is arranged outside the display area in a second direction perpendicular to a first direction in which a substrate is fed. For instance, at least one evaporation source is located in each of first areas defined as areas extending from edges of a maximum substrate among substrates being able to be fed by a feeder which edges extend in the first direction, inwardly of the substrate by a predetermined length in a second direction perpendicular to the first direction. A predetermined length is set equal to 40 mm, for instance. This ensures that evaporated material flies to all points in the display area from outside of the display area in the second direction. As a result, it would be possible to form a protection film having uniform crystal alignment, entirely in the display area. Thus, it is possible for the protection film to have enhanced characteristics of secondary electron emission and an enhanced resistance to sputtering entirely in the display area, and there is presented a plasma display panel which has a sufficient driving-margin in a writing discharge, can be driven at a high rate, and has a long voltage lifetime.

The above and other objects and advantageous features of the present invention will be made apparent from the following description made with reference to the accompanying drawings, in which like reference characters designate the same or similar parts throughout the drawings.

### BRIEF DESCRIPTION OF THE DRAWINGS

FIG. 1 is a side view of a conventional apparatus for forming a protection film.

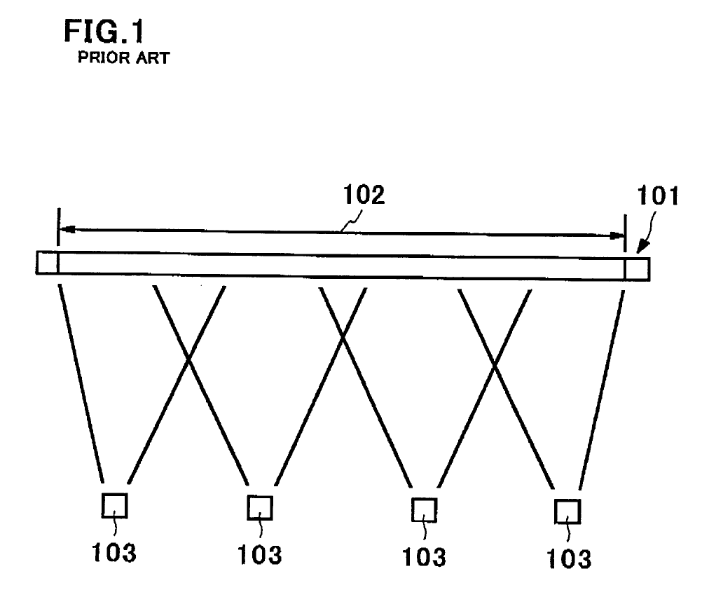

FIG. 2 is an upper plan view of an apparatus for fabricating a plasma display panel, in accordance with the first embodiment of the present invention.

FIG. 3 is a cross-sectional view of the apparatus illustrated in FIG. 2.

FIG. 4 is a graph showing a relation between (111) alignment of a magnesium oxide film and a location of a substrate.

FIG. 5 is a graph showing a relation between (111) alignment of a magnesium oxide film and the angle α.

FIG. 6 is a graph showing a relation between (111) alignment of a magnesium oxide film, and a voltage at which a writing discharge starts and a voltage at which a writing discharge is wrongly generated.

FIG. 7 is a graph showing a relation between (111) alignment of a magnesium oxide film and a discharge delay time.

FIG. 8 is a graph showing a relation between (111) alignment of a magnesium oxide film and a voltage lifetime.

FIG. 9 is a graph showing a relation between a thickness of a magnesium oxide film and a voltage lifetime.

FIG. 10 is an upper plan view of an apparatus for fabricating a plasma display panel, in accordance with the second embodiment of the present invention.

### DESCRIPTION OF THE PREFERRED EMBODIMENTS

The inventors had conducted the experiments a lot for accomplishing the above-mentioned objects, and found out that even if a protection film is formed to have a uniform thickness in a width-wise direction of a substrate, crystal alignment of the protection film is lowered at opposite ends of a substrate in the width-wise direction. The inventors had further found out that if a protection film comprised of a magnesium oxide film had (111)-aligned crystals, the protection film could have enhanced characteristics of secondary electron emission and enhanced resistance to sputtering, but if (111)-alignment is reduced, such characteristics and resistance are also deteriorated.

The present invention was made based on the discovery mentioned above,

Preferred embodiments in accordance with the present invention will be explained hereinbelow with reference to drawings.

[First Embodiment]

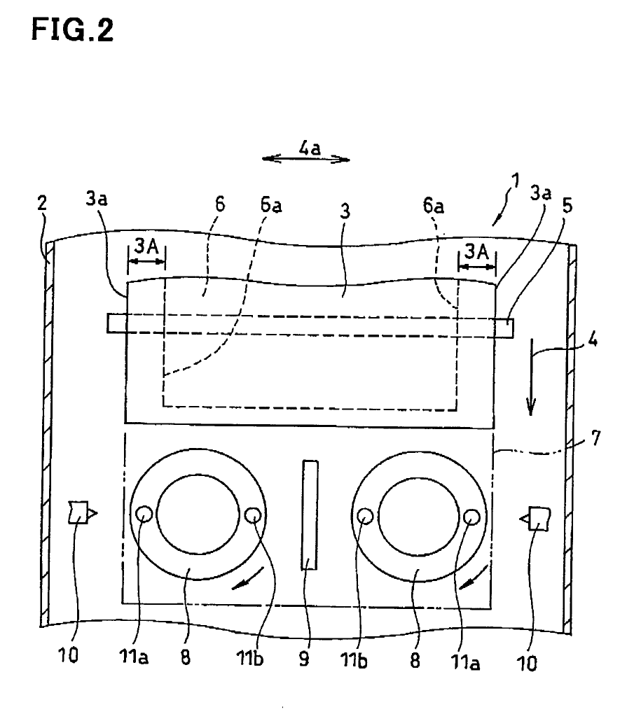

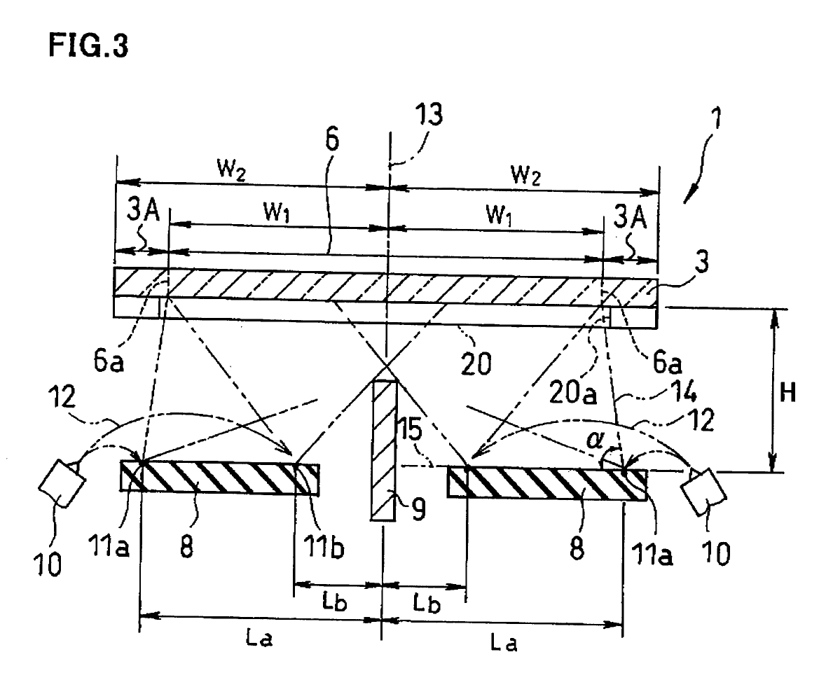

FIG. 2 is an upper plan view of an apparatus fabricating a plasma display panel, in accordance with the first embodiment of the present invention, and FIG. 3 is a cross-sectional view of the apparatus illustrated in FIG. 2.

The apparatus 1 includes a vacuum chamber 2, and a substrate-feeder 5 which feeds a substrate 3 in a first direction 4 such that the substrate 3 passes over a film-forming position 7.

The substrate 3 has the same structure as the structure of the above-mentioned front substrate. In FIG. 2, the scanning and common electrodes and the transparent dielectric layer are formed on a lower surface of the substrate 3. The substrate 3 has a display area 6 in which a protection film comprised of a magnesium oxide film is formed by the apparatus 1.

The display area 6 is located centrally of the substrate 3. Areas of the substrate 3 outside the display area 6, that is, areas sandwiched between edges 6a of the display area 6 extending in the first direction 4 and edges 3a of the substrate 3 extending in the first direction 4 define first areas 3A. In other words, the first areas 3A may be defined as areas extending from the edges 3a of the substrate 3 inwardly of the substrate 3 by a predetermined length in a second direction 4a perpendicular to the first direction 4.

For instance, a predetermined length is preferably determined assuming that the substrate 3 is a maximum-sized substrate among substrates being able to be fed by the substrate-feeder 5, in which case, a predetermined length is set equal to 40 mm.

The substrates 3 having different sizes from one another are introduced into the apparatus 1, and in addition, the substrates 3 each including the display area 6 having a size different from one another are introduced into the apparatus 1.

Two ring-hawses 8 are arranged in the second direction 4a downstream of the film-forming position 7 in the vacuum chamber 2. Rotators (not illustrated) rotate the ring-hawses 8.

Between the ring-hawses 8 stands a partition plate 9. The partition plate 9 has opposite surfaces perpendicular to the second direction 4a.

Electron guns 10 are arranged facing the ring-hawses 8. Specifically, the ring-hawses 8 are located between the electron guns 10 and the partition plate 9. Each of the electron guns 10 irradiate electron beams 12 to both first portions 11a of the ring-hawses 8 located closest to the electron guns 10 and second portions 11b of the ring-hawses 8 located remotest from the electron guns 10. Magnesium oxide (MgO) is evaporated from the first and second portions 11a and 11b of the ring-hawses 8.

Specifically, the apparatus 1 includes four MgO evaporation sources which are arranged in a line in the second direction 4a in facing relation to the display area 6 while the substrate 3 is in the film-forming position 7. The MgO evaporation sources are located so as for a magnesium oxide film to have a uniform thickness in the display area 6.

As illustrated in FIG. 3, a mask 20 is closely adhered to a lower surface of the substrate 3. The mask 3 is formed centrally with a rectangular opening 3a which defines an area in which a magnesium oxide film is formed by evaporation. The opening 3a entirely covers the display area 6 therewith, and is larger than the display area 6 at four sides by about 5 mm, which is because a resultant film would not have a uniform thickness in the vicinity of edges of the opening 20a.

A unit for generating a magnetic field in a space through which the electron beams 12 pass to thereby control a path of the electron beams 12 is positioned in the vicinity of each of the ring-hawses 8.

The partition plate 9 interrupts a magnetic field. Hence, a magnetic field can be controlled independently of each other at opposite sides of the partition plate 9.

An exhaust unit (not illustrated) arranged outside the vacuum chamber 2 keeps the vacuum chamber 2 in vacuum. In FIG. 3, the vacuum chamber 2 and the substrate-feeder 5 are omitted for simplification.

With reference to FIG. 2, the firs portion or evaporation source 11a is arranged outside the display area 6 in the second direction 4a, as viewed from upward of the substrate 3. In other words, the evaporation source 11a is arranged in each of the first areas 3A.

Specifically, a distance La between a vertical plane 13 passing through a center of the substrate 3 in the second direction 4a and the first portion 11a is longer than a distance W1 between the vertical plane 13 and the edges 6a of the display area 6, but shorter than a distance W2 between the vertical plane 13 and the edges 3a of the substrate 3.

When the substrate 3 is in the film-forming position 7, an angle defined by a first line 14 and a second line 15 is equal to or smaller than 80 degrees. The first line 14 is defined as a line connecting a center of the first portion 11a to a point on the edges 6a of the display area 6 which point is closest to the center of the first portion 11a, and the second line 15 is defined as a line horizontally extending from the center of the first portion 11a in the second direction 4a.

If the first area 3A is designed to have a length of 40 mm, a difference between the lengths W1 and W2 is also equal to 40 mm, and the edges 6a of the display area 6 are located at 40 mm inwardly of the edges 3a of the substrate 3.

Hereinbelow is explained an operation of the apparatus 1. It is assumed that one display area 6 is defined in the substrate 3. The display area may have any size such as 55-size or 60-size.

As illustrated in FIGS. 2 and 3, the substrate 3 is introduced into the vacuum chamber 2.

Then, the substrate-feeder 5 feeds the substrate 3 in the first direction 4. Then, the electron guns 10 start irradiation of the electron beams 12. The above-mentioned unit generates a magnetic field in an area through which the electron beams 12 pass, in order to control a path of the electron beams 12. As a result, the electron beams 12 are irradiated alternately to the first portions 11a and the second portions 11b. Thus, magnesium oxide in the first and second portions 11a and 11b is evaporated.

Since the rotators rotate the ring-hawses 8, fresh magnesium oxide is supplied to the first and second portions 11a and 11b.

When the substrate 3 reaches the film-forming position 7, magnesium oxide molecules evaporated from the first and second portions 11a and 11b of the ring-hawses 8 are adhered to the substrate 3 in the display area 6, and resultingly, a magnesium oxide film is formed in the display area 6. Magnesium oxide molecules fly to the display area 6 in opposite directions in the second direction 4a. The thus stacked magnesium oxide makes a protection film in the front substrate of a plasma display panel.

The thus formed magnesium oxide film has face-centered cubic (fcc) crystal structure, and has a (111)-aligned surface. For instance, the magnesium oxide film includes pillar-shaped crystals extending perpendicularly to a surface of the substrate 3.

Hereinbelow are explained limited figures found in the first embodiment.

As mentioned above, the angle α defined by the first line 14 and the second line 15 is set equal to or smaller than 80 degrees.

If the angle is over 80 degrees, evaporated magnesium oxide molecules are irradiated to the display area 6 in the vicinity of the edges 6a thereof in deviated directions, resulting in reduction crystal alignment of a protection film, and hence, resulting in reduction in both characteristics of secondary electron emission and a resistance to sputtering. Accordingly, the angle is preferably equal to or smaller than 80 degrees.

Hereinbelow is explained in detail the reason for setting the angle equal to or smaller than 80 degrees.

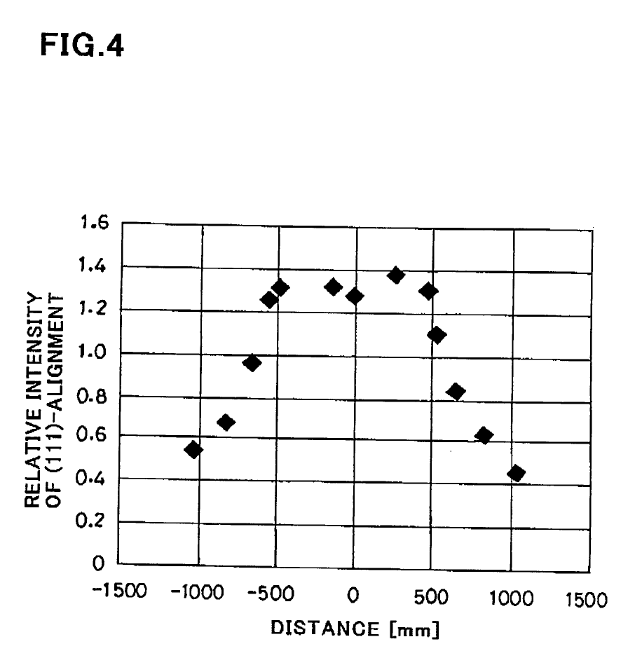

FIG. 4 is a graph showing a relation between (111)-alignment of a magnesium oxide film and a location of the substrate 3. In FIG. 4, an x-axis indicates a location of the substrate 3 in the second direction 4a, and a y-axis indicates an intensity of (111) diffraction ray of a magnesium oxide film measured by means of an X-ray diffractometer. The y-axis in FIG. 4 indicates a distance from a center of the substrate 3 in the second direction 4a, wherein a distance in a right half of the substrate 3 is shown as a positive distance and a distance in a left half of the substrate 3 is shown as a negative distance.

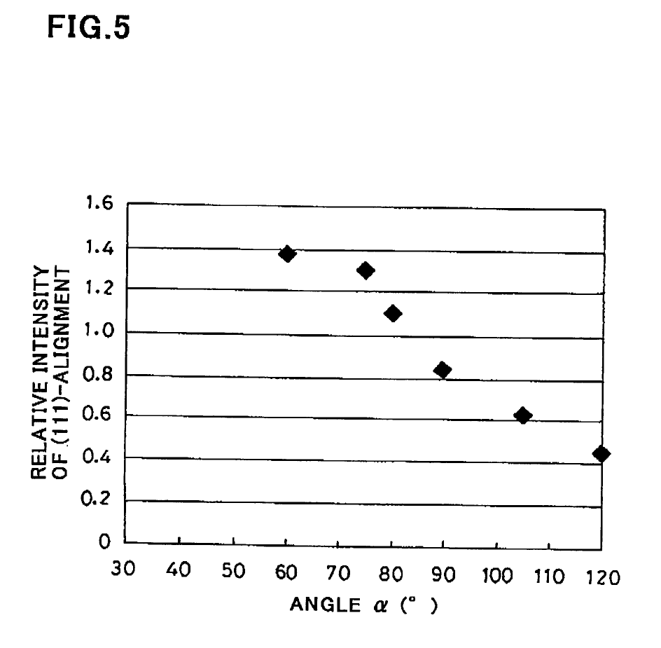

FIG. 5 is a graph showing a relation between (111)-alignment of a magnesium oxide film and an angle α. In FIG. 5, an x-axis indicates an angle α defined by a line connecting a point in the substrate 3 to an evaporation source located outermost among a plurality of evaporation sources, and a line horizontally extending in the second direction 4a from the evaporation source located outermost among a plurality of evaporation sources.

It is assumed that a magnesium oxide film is formed in the apparatus 1 illustrated in FIGS. 2 and 3 in which dimensions are as follows.

Distance La between the vertical plane 13 and the center of the first portion 11a: 710 mm

Distance Lb between the vertical plane 13 and the center of the second portion 11b: 190 mm

Distance W2 between the vertical plane 13 and the edges 3a of the substrate 3: 760 mm

Distance W1 between the vertical plane 13 and the edges 6a of the display area 6: 600 mm

Distance H between the substrate 3 and the center of the first portion 11a; 655 mm

In the case that the distance W1 is set equal to 600 mm, the substrate 3 is placed such that the display area 6 has a longitudinal length equal to 2W1, in which case, if the display area 6 has an aspect ratio of 16:9, the display area 6 is of 54-size, that is, a plasma display panel has a size of 675 mm×1200 mm.

The vacuum chamber 2 is controlled to have a vacuum degree of 3.1×10⁻² Pa, and the electron guns 10 emit an output of 300 mA.

After the formation of a magnesium oxide film, crystal alignment of a resultant magnesium oxide film is measured by means of an X-ray diffractometer. The results of the measurement are shown in FIGS. 4 and 5.

A size of a plasma display panel is equal to a sum of the display area 6 and the first areas 3A arranged around the display area 6. In general, it is necessary for the first area 3A to have a width of about 40 mm at the smallest. Hence, vertical and horizontal length of a plasma display panel is equal to a sum of vertical and horizontal length of the display area 6 and 80 mm or greater. In order to have one plasma display panel out of one substrate, the substrate has to have a size which is larger than a size of a plasma display panel and which allows the substrate to be introduced into the apparatus 1.

A size of the substrate 3 is decided taking costs into consideration. A size of the substrate 3 may be decided such that a plurality of the display areas 6 having sizes different from one another can be defined in the substrate 3. In FIG. 3, the display area 6 is designed to have a longitudinal length of 2W1 or 1200 mm, whereas the substrate 3 has a longitudinal length of 2W2 or 1520 mm. However, the above-mentioned dimensions are just an example, and it should be noted that the apparatus 1 is not to be limited to the above-mentioned dimensions.

As illustrated in FIG. 4, the resultant magnesium oxide film is (111)-aligned, and it is not found that the magnesium oxide film is aligned in other directions. In addition, the magnesium oxide film has an almost uniform thickness.

An intensity of (111) diffraction ray of the magnesium oxide film is higher in an area in which a distance from the center of the substrate 3 is in the range of ±500 mm in the second direction 4a, than in other areas, and is smaller at a location farther away from the center of the substrate 3 in an area in which a distance from the center of the substrate 3 is over 500 mm and below −500 m. This is because evaporated magnesium oxide molecules do not fly to the display area 6 from opposite sides of the display area 6 in the latter area. The intensity of (111) diffraction ray of the magnesium oxide film is slightly reduced around the distance of zero. This is because evaporated magnesium oxide molecules are slightly interrupted to reach the display area 6 by the partition plate 9.

As illustrated in FIG. 4, the intensity of (111) diffraction ray is maximum at about 450 mm from the center of the substrate 3 in the second direction 4a, and is reduced towards the edges 3a of the substrate 3. For instance, the intensity of (111) diffraction ray at 600 mm from the center of the substrate 3 in the second direction 4a is reduced by 15% relative to the maximum intensity.

The distance of about 450 mm from the center of the substrate 3 corresponds to a center between the first portions 11a and the second portions 11b.

[La (710 mm)+Lb (190 mm)]/2=450 mm

The above-mentioned angle α defined by the first line 14 and the second line 15 satisfies the equation (A) wherein “x [mm]” indicates a distance from the center of the substrate 3 in the second direction 4a.

tan α=H/(La−x) (A)

Introducing the above-mentioned dimensions into the equation (A), the angle α is calculated to be 80 degrees. Hence, in an area in which the angle α is equal to or smaller than 80 degrees, the intensity of (111) diffraction ray is 15% or smaller of the maximum intensity, ensuring stable characteristics of magnesium oxide film.

Accordingly, if the display area 6 is designed to have a fixed size, it would be possible to form a magnesium oxide film having uniform characteristics entirely in the display area 6 by setting the above-mentioned angle α at the edge 6a of the display area 6 equal to or smaller than 80 degrees.

FIG. 5 shows the same results as FIG. 4. In FIG. 5, an x-axis indicates the above-mentioned angle α which is calculated in equivalence with the above-mentioned distance from the center of the substrate 3 in the second direction 4a.

As is understood in view of FIG. 5, in an area in which the angle α is equal to or smaller than 80 degrees, the intensity of (111) diffraction ray is 15% or smaller of the maximum intensity.

The reasons why (111)-alignment of the magnesium oxide film is reduced if evaporated magnesium oxide molecules are irradiated to the display area 6 in deviated directions are considered that (111)-plane of magnesium oxide crystals is inclined, and that crystallinity of the magnesium oxide film is deteriorated. In accordance with the research having been conducted by the inventors by means of X-ray diffractometer, it has been confirmed that the firstly mentioned reason was correct to some degree, that is, some relation was found between a direction in which evaporated magnesium oxide molecules are irradiated and an inclination of grain alignment. However, it has not been confirmed whether the secondly mentioned reason was correct.

Hereinbelow is explained in detail reduction in characteristics of a protection film, if (111)-alignment of a magnesium oxide film is reduced.

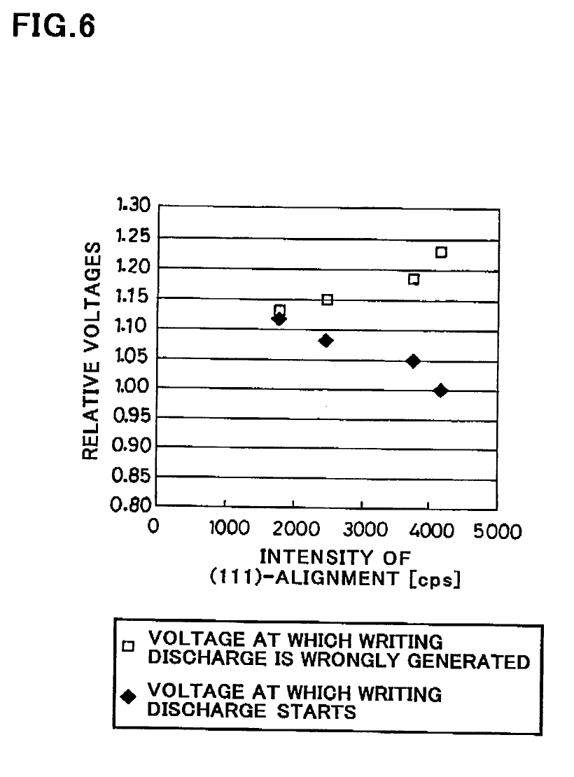

FIG. 6 is a graph showing a relation between (111)-alignment of a magnesium oxide film, and a voltage at which a writing discharge starts and a voltage at which a writing discharge is wrongly generated. In FIG. 6, an x-axis indicates an intensity of (111)-alignment normalized by a thickness of a magnesium oxide film, and a y-axis indicates a relative of a voltage at which a writing discharge starts and a voltage at which a writing discharge is wrongly generated.

In FIG. 6, white hollow squares (□) indicate a voltage at which a writing discharge is wrongly generated, and black solid rhombuses (♦) indicate a voltage at which a writing discharge starts. These voltages are expressed as relatives in the assumption that a voltage at which a writing discharge starts is defined as one (1) when an intensity of (111)-alignment is 4200 cps.

Figures plotted in FIG. 6 are shown in Table 1. As shown in FIG. 6 and Table 1, as an intensity of (111)-alignment increases, a voltage at which a writing discharge starts is reduced, and a voltage at which a writing discharge is wrongly generated is increased. In Table 1, “−” indicates no data.

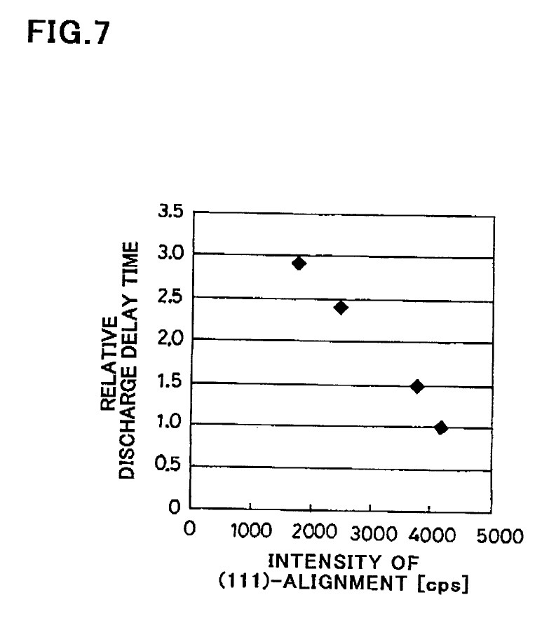

FIG. 7 is a graph showing a relation between (111)-alignment of a magnesium oxide film and a discharge delay time. In FIG. 7, an x-axis indicates an intensity of (111)-alignment normalized by a thickness of a magnesium oxide film, and a y-axis indicates a relative of a discharge delay time of a writing discharge. The discharge delay time is expressed as relatives in the assumption that a discharge delay time is defined as one (1) when an intensity of (111)-alignment is 4200 cps.

Figures plotted in FIG. 7 are shown in Table 1. As shown in FIG. 7 and Table 1, as an intensity of (111)-alignment increases, a discharge delay time is reduced.

The reason why a discharge delay time is reduced if an intensity of (111)-alignment increases is not presented, however, it is considered that since (111)-plane of magnesium oxide crystal is a densified plane, electric charges cannot escape from a surface of a magnesium oxide film, if a magnesium oxide film is (111)-aligned, and resultingly, wall charges can be kept alive for a long time, and thus, a discharge delay time is reduced.

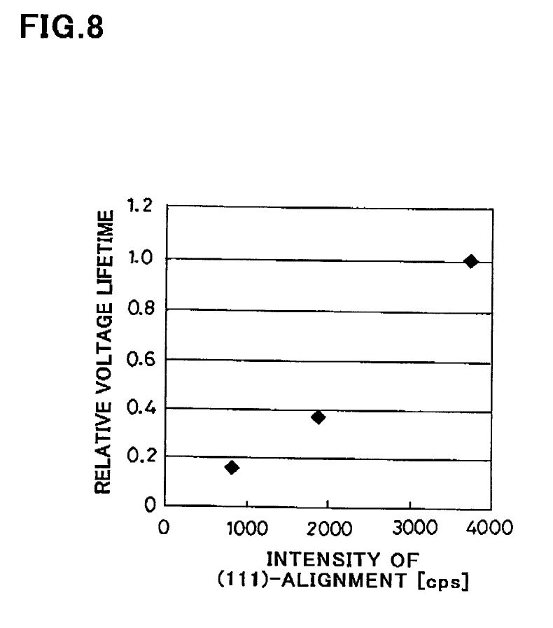

FIG. 8 is a graph showing a relation between (111)-alignment of a magnesium oxide film and a voltage lifetime. In FIG. 8, an x-axis indicates an intensity of (111)-alignment normalized by a thickness of a magnesium oxide film, and a y-axis indicates a relative of a voltage lifetime. The voltage lifetime is expressed as relatives in the assumption that a voltage lifetime is defined as one (1) when an intensity of (111)-alignment is 4200 cps.

Figures plotted in FIG. 8 are shown in Table 1. As shown in FIG. 8 and Table 1, as an intensity of (111)-alignment increases, a voltage lifetime is reduced. This is considered because since (111)-plane of magnesium oxide crystal is a densified plane, a resistance to sputtering is enhanced if a magnesium oxide film is (111)-aligned.

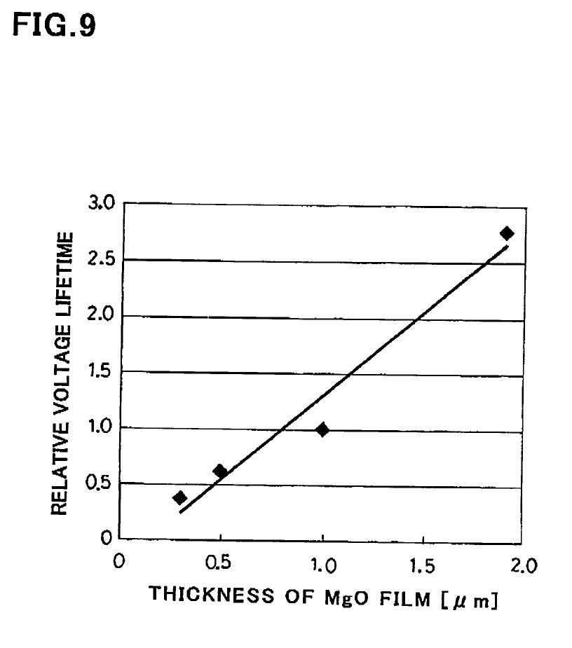

For reference, a relation between a thickness of a magnesium oxide film and a voltage lifetime is shown in FIG. 9. In FIG. 9, an x-axis indicates a thickness of a magnesium oxide film, and a y-axis indicates a relative of a voltage lifetime. The voltage lifetime is expressed as relatives in the assumption that a voltage lifetime is defined as one (1) when an intensity of (111)-alignment is 4200 cps.

As is understood in view of FIG. 9, a thickness of a magnesium oxide film is almost in proportion to a voltage lifetime, and hence, as a thickness increases, a voltage lifetime increases.

TABLE 1

| (111)- | | | Discharge | |
|---|---|---|---|---|
| Alignment | Voltage A | Voltage B | Delay Time | Voltage Lifetime |
| Intensity [cps] | (Relatives) | (Relatives) | (Relatives) | (Relatives) |
| 840 | — | — | — | 0.16 |
| 1800 | 1.11 | 1.13 | 2.92 | — |
| 1900 | — | — | — | 0.36 |
| 2500 | 1.08 | 1.15 | 2.42 | — |
| 3780 | — | — | — | 1.00 |
| 3800 | 1.05 | 1.18 | 1.50 | — |
| 4200 | 1.00 | 1.23 | 1.00 | — |

(Voltage A indicates a voltage at which a writing discharge starts, and Voltage B indicates a voltage at which a writing discharge is wrongly generated.)

In the apparatus 1 in accordance with the first embodiment, the first portions 11a of the evaporation sources are positioned outside the display area 6 in the second direction 4a, namely, within the first areas 3A defined as areas sandwiched between the edges 6a of the display area 6 and the edges 3a of the substrate 3. This ensures that evaporated magnesium oxide molecules enter the display area 6 from opposite sides thereof in the second direction 4a. Thus, it is possible to form a magnesium oxide film having uniform crystal alignment entirely in the display area 6.

In particular, the intensity of (111) diffraction ray is 15% or smaller of the maximum intensity in an area in which the angle α is equal to or smaller than 80 degrees, ensuring formation of uniformly (111)-aligned magnesium oxide film.

In an area just above the second portions 11b in the display area 6, an incident angle of evaporated magnesium oxide molecules is greater than 80 degrees. However, no problems are caused with respect to crystallinity of a magnesium oxide film, because an incident angle of evaporated magnesium oxide coming from the first portion 11a in the ring-hawse 8 to which the above-mentioned second portion 11b belongs, and the second portion 11b in the other ring-hawse 8 is equal to or smaller than 80 degrees.

Thus, it is possible to form a magnesium oxide film entirely in the display area 6 which magnesium oxide film has enhanced characteristics of secondary electron emission and an enhanced resistance to sputtering. Accordingly, the plasma display panel in accordance with the first embodiment makes it possible to lower a voltage at which a writing discharge starts in each of cells, raise a voltage at which a writing discharge is wrongly generated, reduce a discharge delay time, and lengthen a voltage lifetime. Thus, the plasma display panel has a sufficient driving-margin in a writing discharge, can be driven at a high rate, and has a long voltage lifetime.

In the first embodiment, a distance (between the first portions 11a and a distance H between the substrate 3 and the first/second portions 11a/11b may be varied, for instance, in accordance with a size of the display area 6.

Assuming the display area 6 has a length A or B (A>B) in the second direction 4a, the above-mentioned distances (La×2 and H) selected when the display area 6 has a length B is equal to or smaller than the distances selected when the display area 6 has a length A. In the first embodiment, the display area 6 has a length of 1200 mm (W1×2) in the second direction 4a, and the distance H is 655 mm. If the display area 6 is designed to have a length smaller than 1200 mm in the second direction 4a, the distance H may be made smaller in proportion to the length of the display area 6.

A distance (La×2) between the first portions 11a may be made smaller unless the angle α is equal to or smaller than 80 degrees. For instance, the distances La×2 and H selected when the display area 6 has a length of 1000 mm in the second direction 4a may be set smaller than the distances La×2 and H selected when the display area 6 has a length of 1200 mm in the second direction 4a. This makes it possible to enhance an evaporation rate of magnesium oxide without deterioration of crystallinity of a magnesium oxide film, and hence, enhance a fabrication yield of a plasma display panel.

[Second Embodiment]

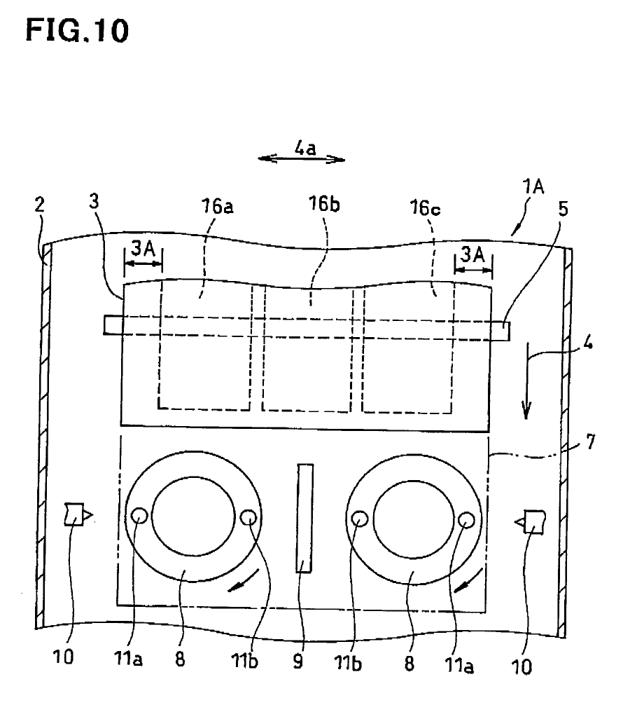

FIG. 10 is an upper plan view of an apparatus 1A for fabricating a plasma display panel, in accordance with the second embodiment of the present invention.

Parts or elements that correspond to those of the apparatus 1 in accordance with the first embodiment have been provided with the same reference numerals, and operate in the same manner as corresponding parts or elements in the first embodiment, unless explicitly explained hereinbelow.

The second embodiment is different from the first embodiment in that three display areas 16a, 16b and 16c are defined in the substrate 3. Except the number of display areas to be defined in the substrate 3, the apparatus 1A in accordance with the second embodiment is identical in structure with the apparatus 1 in accordance with the first embodiment. As illustrated in FIG. 10, when a plurality of display areas is defined in a single substrate, the display areas are arranged so as to have a longitudinal side extending in the first direction 4.

As illustrated in FIG. 10, three display areas 16a, 16b and 16c are defined in the substrate 3. They are arranged in this order in the second direction 4a. For instance, the display areas 16a to 16c are 37-sized.

In the second embodiment, the first portions 11a of evaporation sources are arranged in the first areas 3A each located remoter from the display area 16b than the display area 16a and remoter from the display area 16b than the display area 16c. Thus, evaporated magnesium oxide molecules fly to entirety of the display areas 16a to 16c from opposite sides of them in the second direction 4a, ensuring formation of a magnesium oxide film having uniform crystallinity.

A method of fabricating a plasma display panel through the apparatus 1A is identical with a method of fabricating a plasma display panel through the apparatus 1 in accordance with the first embodiment.

One display area 6 is defined in the substrate 3 in the first embodiment, and three display areas 16a to 16c are defined in the substrate 3 in the second embodiment. The number of display areas to be defined in a substrate is not to be limited to one or three, but it should be noted that the number may be two or four or greater. When two display areas are defined in a substrate, they may be 50-sized or larger, for instance.

In the first and second embodiments, a magnesium oxide film is formed by vacuum evaporation through the use of electron guns. As an alternative, a magnesium oxide film may be formed by vacuum evaporation in which resistors are heated, or by ion-plating. When a magnesium oxide film is formed by ion-plating, an area in which plasma is generated is formed in place of the first and second portions 11a and 11b. In addition, it is possible to control a direction in which evaporated magnesium oxide molecules flies to display areas, in accordance with a voltage to be applied to a substrate.

An alignment of a magnesium oxide film is not to be limited to (111)-alignment. Other alignments may be selected, if enhanced characteristics of secondary electron emission and an enhanced resistance to sputtering are ensured. For instance, (220)-alignment may be selected. A magnesium oxide film can be readily (220)-aligned, if a magnesium oxide film is formed by ion-plating.

Though a protection film is comprised of a magnesium oxide film in the first and second embodiments, a protection film may be comprised of a film composed of materials other than magnesium oxide, if such a film presents enhanced characteristics of secondary electron emission and an enhanced resistance to sputtering.

The apparatuses 1 and 1A are designed to include four evaporation sources 11a and 11b in the first and second embodiments. However, the number of evaporation sources is not to be limited to four. The number of evaporation sources may be three or smaller, or five or greater. However, if the number of evaporation sources is too small, it would be difficult to form a protection film having a uniform thickness, and if the number of evaporation sources is too large, a temperature of a substrate highly raises when a protection film is formed, resulting in a high difference in a temperature of a substrate between before and after a protection film is formed, causing a substrate to be cracked.

In the first and second embodiments, the first portions 11a are arranged in alignment with the first areas 3A of the substrate 3. As an alternative, the first portions 11a may be arranged outside the first areas 3A in the second direction 4a.

While the present invention has been described in connection with certain preferred embodiments, it is to be understood that the subject matter encompassed by way of the present invention is not to be limited to those specific embodiments. On the contrary, it is intended for the subject matter of the invention to include all alternatives, modifications and equivalents as can be included within the spirit and scope of the following claims.

The entire disclosure of Japanese Patent Application No. 2002-filed on, 2002 including specification, claims, drawings and summary is incorporated herein by reference in its entirety.

What is claimed is:

1. An apparatus for fabricating a plasma display panel, said apparatus forming a protection film on a substrate of a plasma display panel in a display area, comprising:
(a) a vacuum chamber;
(b) a feeder which feeds said substrate in a first direction in said vacuum chamber; and
(c) a plurality of evaporation sources located in alignment with said display area of said substrate when said substrate is in a film-forming position,
wherein at least one of said evaporation sources is located outside said display area in a second direction perpendicular to said first direction.

2. An apparatus for fabricating a plasma display panel, said apparatus forming a protection film on a substrate of a plasma display panel in a display area, comprising:
(a) a vacuum chamber;
(b) a feeder which feeds said substrate in a first direction in said vacuum chamber; and
(c) a plurality of evaporation sources located in alignment with said display area of said substrate when said substrate is in a film-forming position,
wherein at least one of said evaporation sources is located in each of first areas defined as areas extending from edges of a maximum substrate among substrates being able to be fed by said feeder which edges extend in said first direction, inwardly of said substrate by a predetermined length in a second direction perpendicular to said first direction.

3. The apparatus as set forth in claim 2, wherein said predetermined length is equal to 40 mm.

4. The apparatus as set forth in claim 2, wherein said at least one of said evaporation sources is located outside said first area in said second direction.

5. The apparatus as set forth in claim 2, wherein said protection film is formed by vacuum evaporation.

6. The apparatus as set forth in claim 5, further comprising an electron gun which irradiates electron beams to said evaporation sources for heating and evaporating said evaporation sources.

7. The apparatus as set forth in claim 2, wherein an angle defined by a first line and a second line is equal to or smaller than 80 degrees wherein said first line is defined as a line, when said substrate is in said film-forming position, connecting each of said at least one of said evaporation sources to a point on each of lines extending in the first direction at a distance of said predetermined length from said edges of said substrate which point is closest to each of said at least one of said evaporation sources, and said second line is defined as a line extending in said second direction from said at least one of said evaporation sources.

8. The apparatus as set forth in claim 2, wherein an angle defined by a first line and a second line is equal to or smaller than 80 degrees wherein said first line is defined as a line, when said substrate is in said film-forming position, connecting each of said at least one of said evaporation sources to a point on said substrate which point is closest to each of said at least one of said evaporation sources, and said second line is defined as a line extending in said second direction from said at least one of said evaporation sources.

9. The apparatus as set forth in claim 2, wherein a distance between said evaporation sources and said substrate may be selected from a plurality of distances different from one another, and, assuming that said display area has a length A or B (A>B) in said second direction, a distance selected when said display area has a length B is equal to or smaller than a distance selected when said display area has a length A.

10. The apparatus as set forth in claim 2, wherein each of said evaporation sources is comprised of magnesium oxide, and said apparatus forms a protection film comprised of a magnesium oxide film.

11. The apparatus as set forth in claim 10, wherein said magnesium oxide film has a face-centered cubic structure (fcc).

12. The apparatus as set forth in claim 10, wherein said magnesium oxide film has a (111)-aligned surface.

13. An apparatus for fabricating a plasma display panel, said apparatus forming a protection film on a substrate of a plasma display panel in a display area, comprising:
(a) a vacuum chamber;
(b) a feeder which feeds said substrate in a first direction in said vacuum chamber;
(c) a plurality of evaporation sources located in alignment with said display area of said substrate when said substrate is in a film-forming position; and
(d) a mask positioned between said substrate and said evaporation sources, and having an opening in alignment with said display area,
wherein at least one of said evaporation sources is located outside said opening in a second direction perpendicular to said first direction and parallel with a surface of said substrate.

14. The apparatus as set forth in claim 13, wherein said protection film is formed by vacuum evaporation.

15. The apparatus as set forth in claim 14, further comprising an electron gun which irradiates electron beams to said evaporation sources for heating and evaporating said evaporation sources.

16. The apparatus as set forth in claim 13, wherein an angle defined by a first line and a second line is equal to or smaller than 80 degrees wherein said first line is defined as a line connecting each of evaporation sources located outermost in said second direction among said evaporation sources, to a point in said opening which point is closest to said each of evaporation sources, and said second line is defined as a line extending in said second direction from said each of evaporation sources.

17. The apparatus as set forth in claim 13, wherein a distance between said evaporation sources and said substrate may be selected from a plurality of distances different from one another, and, assuming that said display area has a length A or B (A>B) in said second direction, a distance selected when said display area has a length B is equal to or smaller than a distance selected when said display area has a length A.

18. The apparatus as set forth in claim 13, wherein each of said evaporation sources is comprised of magnesium oxide, and said apparatus forms a protection film comprised of a magnesium oxide film.

19. The apparatus as set forth in claim 18, wherein said magnesium oxide film has a face-centered cubic structure (fcc).

20. The apparatus as set forth in claim 18, wherein said magnesium oxide film has a (111)-aligned surface.

21. A method of fabricating a plasma display panel, including the step of forming a protection film on a substrate of said plasma display panel in a display area, said step includes:
(a) feeding said substrate in a first direction in a vacuum atmosphere; and
(b) heating and evaporating a plurality of evaporation sources at least one of which is located outside said display area in a second direction perpendicular to said first direction, said evaporation sources being positioned facing said display area of said substrate.

22. The method as set forth in claim 21, wherein said protection film is formed by vacuum evaporation.

23. The method as set forth in claim 21, wherein an angle defined by a first line and a second line is equal to or smaller than 80 degrees wherein said first line is defined as a line connecting each of said at least one of said evaporation sources located outside said display area in said second direction among said evaporation sources, to a point in said display area which point is closest to said at least one of said evaporation sources, and said second line is defined as a line extending in said second direction from said at least one of said evaporation sources.

24. The method as set forth in claim 21, wherein said substrate has at least two display areas each having a size of 50-size or greater.

25. The method as set forth in claim 21, wherein said substrate has at least three display areas.

26. The method as set forth in claim 21, wherein said display area has a size of 55-size or greater.

27. The method as set forth in claim 21, wherein said display area has a size of 60-size or greater.
